(19) United States
(12) Patent Application Publication
(10) Pub. No.: US 2021/0032927 A1
(43) Pub. Date: Feb. 4, 2021

(54) FIRE AND IMPACT RESISTANT DOOR AND LIPPING

(71) Applicant: Scotdor, Glasgow (GB)

(72) Inventor: David BROWN, Glasgow (GB)

(73) Assignee: Scotdor, Glasgow (GB)

(21) Appl. No.: 16/612,054

(22) PCT Filed: May 16, 2018
(86) PCT No.: PCT/GB2018/051324

§ 371 Date: Nov. 8, 2019

(30) Foreign Application Priority Data
May 16, 2017 (GB) 1707832.0
Dec. 13, 2017 (GB) 1720774.7

(51) Int. Cl. E06B 5/16; E04B 1/94

(52) U.S. Cl. CPC E06B 5/164; E04B 1/948; E04B 1/947

(57) ABSTRACT

A fire resistant door leaf (30, 32) comprises a core (42) and a lipping (50, 52) extending along at least one edge (40) of the core (42). The lipping (50, 52) is of plastic material (60) and is bonded to the edge (40) of the core, and comprises at least one strip of intumescent material (62) extending parallel to the edge (40) of the core. The at least one strip of intumescent material (62) is covered by the plastic material (60) of the lipping, and the plastic material (60) is cast or moulded against the at least one strip of intumescent material (62). The fire resistant door leaf (30, 32) may be formed by locating the at least one strip of intumescent material (62) along the edge (40) of the core and subsequently forming the lipping (50, 52) by casting or moulding the plastic material (60) of the lipping to the core in a liquid or semi-liquid state to cover the at least one strip of intumescent material (62) and curing the plastic material in situ (60).

### FIELD OF THE INVENTION

This invention relates to doors and door leafs which are used in building structures, and in particular to doors which are mounted on hinges or pivots to open by swinging or pivoting about a vertical axis, and which are required to be fire resistant or are subject to impact from heavy use. This invention also relates to a method of forming such doors and door leafs.

### BACKGROUND OF THE INVENTION

Conventional doors may be manufactured from one sheet of material, such as graduated density particleboard, or from many components, typically of timber or timber base, either solid or hollow. Typically a door leaf construction may comprise a door core or blank of particle board or other suitable material, which may be faced with opposing surface panels or veneers of timber or other material to provide an attractive surface finish. The vertical edges of the door leaf are provided with a timber edge or lipping, to provide a relatively hard edge to the door. However when a door is used in areas where the door may be subject to heavy or repeated impact loading, for example when trolleys are pushed against the doors, the edges or lippings may be subject to marking and damage.

Where doors are provided as fire resisting components in buildings, in the event of a fire the gaps around the door are commonly filled by intumescent materials which expand when heated and which seal gaps, and protect vulnerable parts of the door from fire, and seal the door by preventing or reducing the spread of smoke. The conventional way of making a door fire resisting is by placing intumescent material around the outside of the door leaf or frame. The intumescent material is commonly placed inside a PVC protective sleeve and fitted within a rebate in the edges of the door or door frame. FIG. 1 shows a prior art door 1 fitted with a timber lipping 4. The door 1 comprises a core 2 of suitable material, for example particle board, with a surface panel 3 comprising a facing or veneer on each face of the core 2. The timber lipping 4 is provided on one or more of the edges of the core, by bonding. A PVC protective sleeve 5 containing intumescent material 6 may be fixed in a longitudinal groove 7 formed in the lipping 4.

These intumescent materials are essential components of fire resisting doors and are vulnerable to damage or removal, either by vandalism or impact during normal use, for example by trolleys. The effectiveness of the intumescent materials can be reduced through degradation of the components due to exposure to atmospheric conditions, impact and mechanical movement.

Timber door edges and lippings, intumescent strips in such door edges and lippings and door faces of timber, laminate and other materials can often be damaged by impact through daily use, for example by impact from trolleys or from hard objects or objects having sharp corners carried by persons passing through the doors. This damage can be unsightly, can provide locations for bacteria and dirt to harbour, and can compromise the fire performance of fire resisting doors.

It is known to provide edge guards to doors, in an attempt to mitigate or avoid damage of this type. For example door edges have been fitted with edge guards of materials such as aluminium, steel, alloy, PVC and resin which fit over the edge of the door core. These edge guards are separate items fitted to the edge of the door. An example of a prior art door 11 with a separate edge guard 20 is shown in FIG. 2. The door 11 comprises a core 12 of suitable material, for example particle board, with a surface panel 13 comprising a facing or veneer on each face of the core 12. An edge guard 20 of aluminium is provided on one or more of the edges of the core, by bonding with adhesive 21 or other suitable means of fixing. The two flanges 22 of the edge guard 20 cover the edges of the surface panels 13. The edge guard 20 includes a longitudinal groove 17 containing intumescent material 16.

Such an edge guard is unsightly, and can also act as a trap for bacteria and dirt to harbour in the spaces between the surface panels 13 and the flanges 22 of the edge guard 20. Moreover, the intumescent material 16 remains exposed and therefore vulnerable to damage or removal, either by vandalism or impact during normal use, reducing the effective fire resistance of the door.

It is an object of the present invention to obviate or mitigate at least one of the disadvantages of prior art doors described above.

### SUMMARY OF THE INVENTION

According to a first aspect of the present invention, there is provided a fire resistant door leaf comprising a core and a lipping extending along at least one edge of the core, wherein the lipping is of plastic material and is bonded to the edge of the core, wherein the lipping comprises at least one strip of intumescent material extending parallel to the edge of the core, and wherein the at least one strip of intumescent material is covered by the plastic material of the lipping.

Because the intumescent material is covered by the plastic material of the lipping it is protected from damage, but will still expand when heated to cause the lipping to move away from the core and seal between the door and an adjacent door or door frame.

The core may be comprise a surface panel on each face of the core. Each surface panel may be a decorative surface panel, such as a veneer of timber.

The lipping may comprise two strips of intumescent material extending parallel to the edge of the core, wherein the strips are arranged to be coplanar and wherein both strips are covered by the plastic material of the lipping. The provision of two strips of intumescent material means that there is a strip close to each side of the door leaf, so that in the case of fire on either side of the door leaf the nearest strip of intumescent material will expand first, giving an appropriate level of protection.

The lipping may comprise a single strip of intumescent material extending parallel to the edge of the core, or the lipping may comprise more than two strips of intumescent material extending parallel to the edge of the core. The number, position and size of the strips of intumescent material may depend on the fire rating of the door leaf, the type of door leaf, the materials of the door leaf, the thickness and size of the door leaf, the proposed environment of use of the door leaf etc.

The at least one strip of intumescent material may be surrounded by the plastic material of the lipping. The plastic material may be cast or moulded around the at least one strip of intumescent material. The plastic material surrounding the at least one strip of intumescent material may be homogenous or unitary in nature. If the plastic material is homogenous or unitary in nature it has no construction joints or gaps in it, so that the intumescent strip is surrounded or encapsulated by the plastic material. The intumescent strip may be bonded directly to the plastic material surrounding it by the curing of the plastic material in contact with the intumescent strip. The intumescent strip may be thereby conjoined with the plastic material.

Alternatively the at least one strip of intumescent material may be sandwiched between the plastic material of the lipping and the core of the door leaf. In such circumstances the intumescent strip is not surrounded by the plastic material of the lipping, but at least part of the intumescent strip is in direct contact with the plastic material. The plastic material may be cast or moulded against the at least one strip of intumescent material. The plastic material in direct contact with the at least one strip of intumescent material may be homogenous or unitary in nature. If the plastic material is homogenous or unitary in nature it has no construction joints or gaps in it, so that the intumescent strip is in direct contact an unbroken casing of plastic material. The intumescent strip may be bonded directly to the plastic material by the curing of the plastic material in contact with the intumescent strip. The intumescent strip may be thereby conjoined with the plastic material.

The plastic material of the lipping may be of polyurethane.

It has been found that covering the strip of intumescent material with polyurethane enables the intumescent material to expand and seal the gap between the door and an adjacent door or door frame effectively, with no loss of performance compared to an exposed strip of intumescent material.

The lipping may be bonded to the core by adhesive, heat bonding or casting.

The lipping may be formed by casting or moulding to the core in a liquid or semi-liquid state and curing in situ.

Alternatively the lipping may be formed by casting or moulding the plastic material in a liquid or semi-liquid state around the one or more strips of intumescent material and curing the plastic material before application of the lipping to the core. The intumescent material may comprise one or more of graphite, ammonium polyphosphate, sodium silicate or mixtures or formulations thereof.

The exterior surface of the lipping may be arcuate or substantially semi-circular in cross-section. Because the strip of intumescent material is not on the exterior surface of the lipping, the designer has more freedom to choose a non-planar exterior surface, because there is no risk of the strip of intumescent material being exposed and susceptible to damage on such a non-planar exterior surface.

The lipping may be substantially rectangular in cross-section.

According to a second aspect of the present invention, there is provided a method of forming a fire resistant door leaf comprising the steps of:
assembling a core of a door leaf;
providing at least one strip of intumescent material along at least one edge of the core;
bonding a lipping of plastic material to the at least one edge of the core, such that the at least one strip of intumescent material is covered by the plastic material of the lipping.

The method may include the step of locating the at least one strip of intumescent material along the at least one edge of the core and subsequently forming the lipping by casting or moulding the plastic material of the lipping to the core in a liquid or semi-liquid state to cover the at least one strip of intumescent material and curing the plastic material in situ.

Alternatively the lipping may be formed by casting or moulding the plastic material in a liquid or semi-liquid state around the one or more strips of intumescent material and curing the plastic material before bonding the lipping to the at least one edge of the core.

The casting or moulding may comprise injection moulding.

The at least one strip of intumescent material may be surrounded by the plastic material of the lipping. The plastic material may be cast or moulded around the at least one strip of intumescent material. The plastic material surrounding the at least one strip of intumescent material may be homogenous or unitary in nature. If the plastic material is homogenous or unitary in nature it has no construction joints or gaps in it, so that the intumescent strip is surrounded or encapsulated by the plastic material. The intumescent strip may be bonded directly to the plastic material surrounding it by the curing of the plastic material in contact with the intumescent strip. The intumescent strip may be thereby conjoined with the plastic material. The lipping may be bonded to the core by adhesive, heat bonding or casting.

The at least one strip of intumescent material may be sandwiched between the plastic material of the lipping and the core of the door leaf. In such circumstances the intumescent strip is not surrounded by the plastic material of the lipping, but at least part of the intumescent strip is in direct contact with the plastic material. The plastic material may be cast or moulded against the at least one strip of intumescent material. The plastic material in direct contact with the at least one strip of intumescent material may be homogenous or unitary in nature. If the plastic material is homogenous or unitary in nature it has no construction joints or gaps in it, so that the intumescent strip is in direct contact an unbroken casing of plastic material. The intumescent strip may be bonded directly to the plastic material by the curing of the plastic material in contact with the intumescent strip. The intumescent strip may be thereby conjoined with the plastic material.

The plastic material of the lipping may be of polyurethane.

The fire resistant door leaf may be a door leaf according to the first aspect of the invention.

According to a third aspect of the present invention, there is provided a lipping for use in a fire resistant door leaf according to the first aspect of the present invention, wherein the lipping comprises a plastic material surrounding at least one strip of intumescent material extending parallel to the lipping, wherein the plastic material is cast or moulded around the at least one strip of intumescent material. The plastic material surrounding the at least one strip of intumescent material may be homogenous or unitary in nature. If the plastic material is homogenous or unitary in nature it has no construction joints or gaps in it, so that the intumescent strip is surrounded or encapsulated by the plastic material. The intumescent strip may be bonded directly to the plastic material surrounding it by the curing of the plastic material in contact with the intumescent strip. The intumescent strip may be thereby conjoined with the plastic material.

The lipping may comprise two strips of intumescent material extending parallel to the lipping, wherein the strips are arranged to be coplanar and wherein both strips are surrounded by the plastic material of the lipping.

The lipping may comprise a single strip of intumescent material extending parallel to the lipping, or the lipping may comprise more than two strips of intumescent material extending parallel to the lipping. The number, position and size of the strips of intumescent material may depend on the fire rating of the door leaf with which the lipping is to be used, the type of door leaf, the materials of the door leaf, the thickness and size of the door leaf, the proposed environment of use of the door leaf etc.

The plastic material of the lipping may be of polyurethane.

It has been found that surrounding or encapsulating the strip of intumescent material with polyurethane enables the intumescent material to expand and seal the gap between the door and an adjacent door or door frame effectively, with no loss of performance compared to an exposed strip of intumescent material.

The lipping may be formed by casting or moulding the plastic material around the intumescent strips in a liquid or semi-liquid state and subsequently curing. The lipping may then be stored and/or transported separately before use in construction of a fire resistant door leaf.

The intumescent material may comprise one or more of graphite, ammonium polyphosphate, sodium silicate or mixtures or formulations thereof.

The exterior surface of the lipping may be arcuate or substantially semi-circular in cross-section. Because the strip of intumescent material is not on the exterior surface of the lipping, the designer has more freedom to choose a non-planar exterior surface, because there is no risk of the strip of intumescent material being exposed and susceptible to damage on such a non-planar exterior surface.

The lipping may be substantially rectangular in cross-section.

According to a fourth aspect of the present invention, there is provided a method of forming a lipping for use in a fire resistant door leaf comprising the steps of:
casting or moulding the lipping from plastic material to surround at least one strip of intumescent material along at least one edge of the core;
curing the plastic material, such that the at least one strip of intumescent material is encapsulated by the plastic material of the lipping.

The lipping may be formed by casting or moulding in a liquid or semi-liquid state and curing in situ.

The casting or moulding may comprise injection moulding.

The plastic material of the lipping may be of polyurethane.

The method may include the further step of storing the lipping before using the lipping in construction of a fire resistant door leaf.

The intumescent material may comprise one or more of graphite, ammonium polyphosphate, sodium silicate or mixtures or formulations thereof.

According to a fifth aspect of the present invention, there is provided an impact resistant door leaf comprising a core, first and second surface panels arranged on opposing sides of the core and a lipping extending along at least one edge of the core, wherein the lipping is of plastic material and is bonded to the edge of the core, wherein the lipping is formed by casting or moulding to the core in a liquid or semi-liquid state and curing in situ,
the lipping having a channel shape in cross-section with a web and first and second flanges substantially perpendicular to the web, the interior surfaces of the web and flanges being bonded to the core, and the exterior surfaces of the first and second flanges being coplanar with the exterior surfaces of the first and second surface panels respectively.

By forming the lipping of plastic material, it can be formed such that its external surfaces are flush with the exterior surfaces of the surface panels, thereby forming a lipping which is tough and impact resistant, but appears to be an integral part of the door leaf. The colour of the lipping can be selected to match the colour of the surface panels. By forming the lipping in situ the lipping is bonded strongly to the core, and so the flanges of the lipping do not have to extend as far along the core as the flanges of the prior art separate edge guards. By forming the lipping in situ no spaces are formed which can collect dirt.

Preferably the lipping extends along the free longitudinal edge of the door leaf. This is the vertical edge opposite the edge to which hinges are fitted. The lipping provides protection against impact by trolleys and the like when they pass through an open door or pair of opposed doors. The free edge is the most susceptible to impact damage, so the other edges of the door leaf may not have such a lipping formed by casting or moulding to the core in a liquid or semi-liquid state and curing in situ.

The plastic material of the lipping may be of polyurethane.

The surface panels may be of timber or other decorative veneer material.

The webs of the channel may extend for between 10 and 50 mm from the flange.

The door leaf may be a fire resistant door leaf according to the first aspect of the invention.

According to a sixth aspect of the present invention, there is provided a method of forming an impact resistant door leaf comprising the steps of:
assembling a core of a door leaf with first and second surface panels arranged on opposing sides of the core,
forming recesses on opposing sides of the core adjacent to a longitudinal edge of the core of the door leaf, such that the core has a reduced thickness at the location of the recesses, and such that the first and second surface panels extend to the recesses;
placing a channel-shaped mould against the mould against the first and second surface panels to define a channel-shaped void around the longitudinal edge of the core.
filling the void formed by the mould with plastic material in a liquid or semi-liquid state;
curing the plastic material in situ to form a lipping of plastic material on the longitudinal edge of the core; and
removing the mould.

Preferably the impact resistant door leaf is a door leaf according to the fifth aspect of the invention.

### BRIEF DESCRIPTION OF THE DRAWINGS

The invention will be described, by way of example only, with reference to the drawings in which:

FIG. 1 shows part of a prior art door leaf with a strip of intumescent material;

FIG. 2 shows a partial sectional view through another prior art door leaf with a separate edge guard;

FIGS. 3A and 3B each show a partial sectional view through a pair of door leafs according to a first aspect of the present invention;

FIGS. 4A and 4B each show a partial sectional view through door leafs according to a first aspect of the present invention;

FIG. 5 shows a partial sectional view through a door leaf according to a second aspect of the present invention;

FIG. 6 shows a partial sectional view through another door leaf and door frame according to a second aspect of the present invention;

FIGS. 7 and 8 show an elevation and a sectional view of a door leaf according to the present invention; and

FIGS. 9 and 10 are schematic sectional views showing a method of manufacturing a door leaf according to the present invention;

### DETAILED DESCRIPTION OF THE DRAWINGS

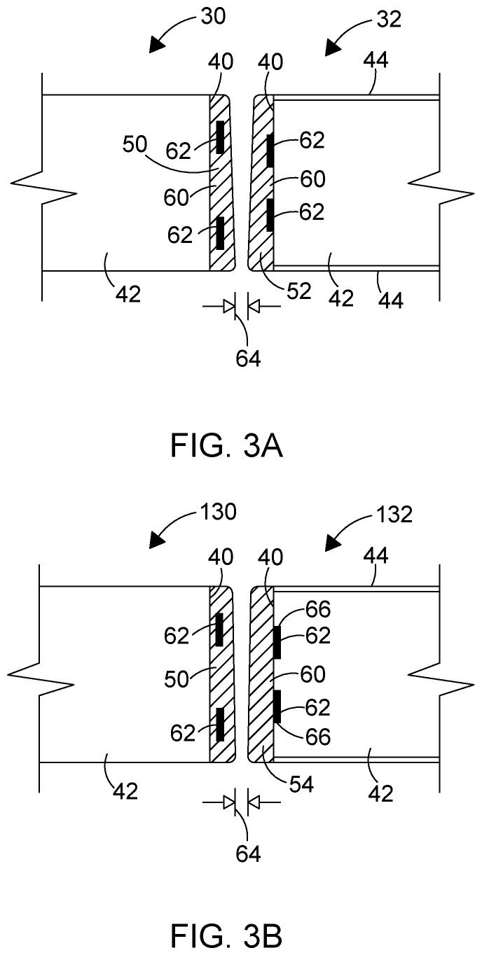

FIG. 3A shows a pair of door leafs 30, 32 according to a first aspect of the present invention. The door leafs are mounted in a door frame (not shown) by means of hinges or pivots on their longitudinal edges opposite to their free longitudinal edges 40 seen in FIG. 3A. The door leaf comprises a core 42. Optionally the core 42 comprises separate surface panels 44 of timber veneer or other decorative surface material (shown on door leaf 32). Attached to the free longitudinal edge 40 is a lipping 50, 52 of plastic material 60, typically polyurethane, which is bonded to the edge 40 of the core 42. However any suitable plastic material 60 can be used for the lipping 50, 52.

The lipping 50 on the first door leaf 30 comprises two strips of intumescent material 62 extending parallel to the edge 40 of the core and surrounded by the plastic material 60 of the lipping 50. In this embodiment the intumescent strips 62 are surrounded or encapsulated by the plastic material 60, providing improved protection to the strips 62, particularly if the lipping 50, including the strips 62, is formed as a separate item, and must be stored and/or transported before being bonded to the edge 40 of the core 42.

The lipping 52 on the second door leaf 32 comprises two strips of intumescent material 62 extending parallel to the edge 40 of the core and sandwiched between the plastic material 60 of the lipping 52 and the longitudinal edge 40 of the core 42, so that the strips of intumescent material 62 are covered by the plastic material 60 of the lipping 52.

The intumescent material 62 may be selected from graphite, ammonium polyphosphate, sodium silicate or mixtures or formulations thereof, but is not limited thereto. Any intumescent material which meets the appropriate fire resistance requirements may be used.

Each lipping 50, 52 is bonded to the core 42 by adhesive, heat bonding or casting. A preferred method of construction is forming the lipping 50, 52 by casting or moulding to the core 42 in a liquid or semi-liquid state and curing in situ. The strips of intumescent material 62 may be held in place while the plastic material 60 is poured into a mould held against the edge 40 of the core 42, or alternatively, in the embodiment of the door leaf 32, the strips of intumescent material 62 may be secured to the longitudinal edge 40 of the core 42 before the mould is placed against the edge 40 of the core 42 and the plastic material 60 is poured into the mould.

Another preferred method of construction is forming the lipping 50, 52 by casting or moulding separately, before subsequently bonding the lipping 50, 52 to the core 42. The lipping 50, 52 may be formed by casting or moulding the plastic material in a liquid or semi-liquid state and curing in situ. The strips of intumescent material 62 may be held in place in a mould while the plastic material 60 is poured into the mould, or the lipping may be formed by injection or extrusion moulding around the strips of intumescent material 62, which are fed at the same speed as the plastic material is injected. The lipping 50, 52 may then be formed in a separate location from the location of the door leaf manufacture. The cured lipping 50, 52, complete with integrated tumescent strips 62, is then bonded to the core 40 by adhesive or any other suitable bonding method. This method of forming the lipping is particularly suitable for the lipping 50 in which the strips of intumescent material 62 are surrounded or encapsulated by the plastic material 60. The plastic material 60 surrounding the intumescent strips 62 is homogenous or unitary in nature, and has no construction joints or gaps in it, so that the intumescent strip 62 is completely surrounded or encapsulated by the plastic material 60, at least in the transverse cross-sectional plane of the lipping 50. The intumescent strip 62 is effectively bonded directly to the plastic material 60 surrounding it by the curing of the plastic material 60 in contact with the intumescent strip 62. The intumescent strip 62 is thereby conjoined with the plastic material 60.

The strips of intumescent material 62 are protected by the strong and tough plastic lipping 50, 52, so that the performance of the intumescent material cannot be reduced by impact damage or vandalism. The lipping 50, 52 may be substantially rectangular in cross section, or may be tapered in thickness from one side of the core 42 to the other, to suit the opening movement of the door leaf 30, 32.

Typically the lippings 50, 52 are separated by a clearance gap 64 of between 2 and 8 mm when the door leafs 30, 32 are mounted in a door frame. The gap 64 must be large enough to allow the door leafs to open without interference, but small enough to allow the gap to be filled by the lipping 50, 52 and/or intumescent material 62 when the intumescent material expands upon exposure to heat of a fire.

FIG. 3B shows another pair of door leafs 130, 132 according to the first aspect of the present invention. Components which are the same as those described above with reference to FIG. 3A have the same reference number and are not further described.

The lipping 50 on the first door leaf 130 comprises two strips of intumescent material 62 extending parallel to the edge 40 of the core and surrounded by the plastic material 60 of the lipping 50. This lipping 50 of this embodiment may be formed by casting or moulding the lipping separately while encapsulating the intumescent strips 62, before adhering the cured lipping 50 to the edge 40 of the core 42.

The lipping 54 on the second door leaf 132 comprises two strips of intumescent material 62 extending parallel to the edge 40 of the core and sandwiched between the plastic material 60 of the lipping 52 and the longitudinal edge 40 of the core 42, so that the strips of intumescent material 62 are covered by the plastic material 60 of the lipping 52. In this embodiment the strips of intumescent material 62 are placed in grooves 66 formed in the edge 40 of the core 42. This embodiment is best formed by casting in situ on the edge 40 of the core 42.

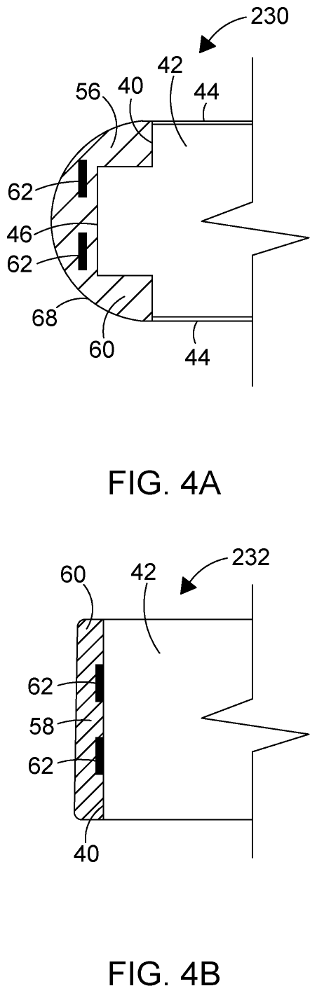

FIGS. 4A and 4B each show another door leaf 230, 232 according to the first aspect of the present invention. Components which are the same as those described above with reference to FIG. 3A have the same reference number and are not further described.

In FIG. 4A the lipping 56 comprises two strips of intumescent material 62 extending parallel to the edge 40 of the core 42 and surrounded by the plastic material 60 of the lipping 50. The core 42 is formed with a longitudinal tongue 46 on its longitudinal edge 40, and the lipping 56 has an exterior surface 68 which is arcuate or substantially semi-circular in cross-section.

The tongue 46 provides additional shear resistance when the lipping 56 is subject to impact forces perpendicular to the plane of the door leaf 230. The exterior surface 68 can have any suitable shape, because the strips of intumescent material 62 are protected inside the plastic material 60 of the lipping 56.

The door leaf 232 is similar to the door leaf 32, but the thickness of the lipping 58 is constant, unlike the tapering thickness of the lipping 52 illustrated in FIG. 3A. The lippings 56, 58 of FIGS. 4A and 4B can be formed in situ on the core 42, or can be formed separately, as described above.

Although the illustrated examples of FIGS. 3A, 3B, 4A and 4B show two coplanar strips of intumescent material 62 in each lipping 50, 52, 54, 56, 58, it is to be understood that the door leaf 30, 32, 130, 132, 230, 232 of the present invention may include a single strip of intumescent material 62, or, if required, more than two strips of intumescent material 62. The strips 62 may be arranged in different positions in the lipping 50, 52, 54, 56, 58 other than those shown in the drawings. The number, position and size of the strips of intumescent material 62 are chosen dependent upon the fire rating of the door leaf, the type of door leaf, the materials of the door leaf, the thickness and size of the door leaf, and/or the proposed environment of use of the door leaf.

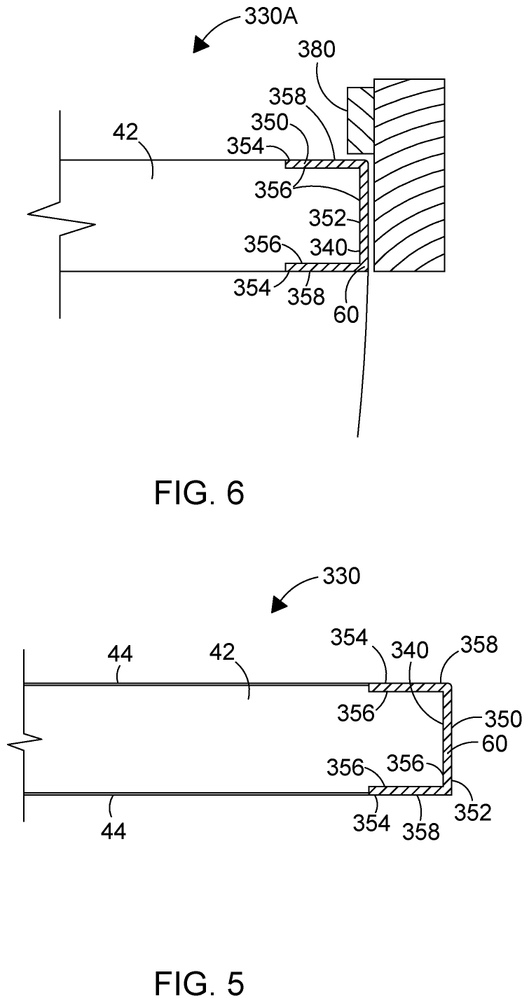

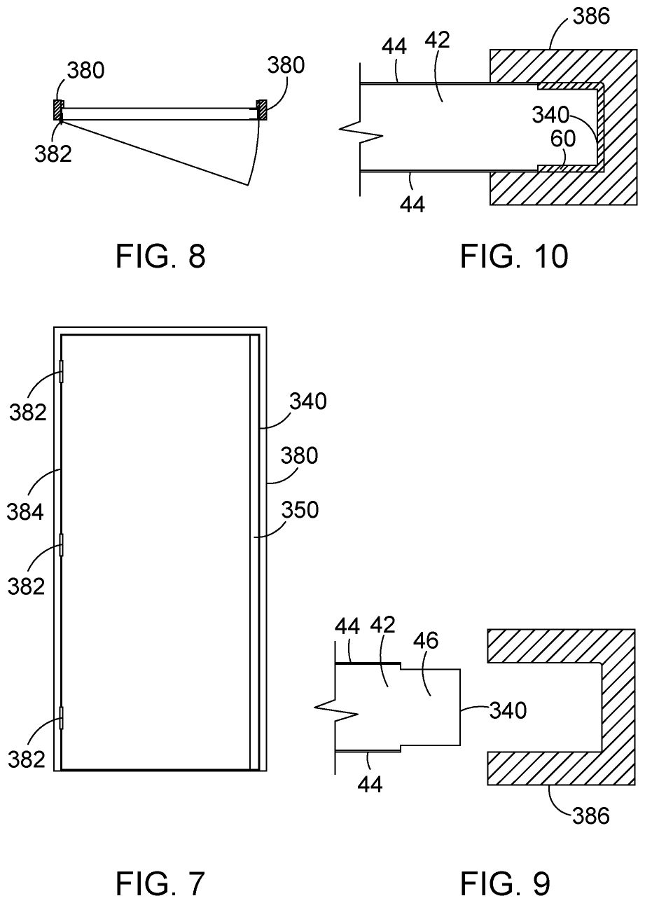

With reference to FIGS. 5 to 10, there is shown a door leaf 330 according to a second aspect of the present invention. The door leaf is mounted in a door frame 380, best seen in FIGS. 7 and 8, by means of hinges 382 or pivots on its longitudinal edge 384 opposite to the free longitudinal edge 340 seen in FIG. 5. The longitudinal edges 340, 384 are vertical edges when the door leaf 330 is mounted in the door frame 380. The door leaf 330 comprises a core 42. The core 42 comprises separate surface panels 44 of timber veneer or other decorative surface material. Attached to the free longitudinal edge 340 is a lipping 350 of plastic material 60, typically polyurethane, which is bonded to the edge 340 of the core 42. However any suitable plastic material 60 can be used for the lipping 350.

FIG. 6 also shows a door leaf 330A according to a second aspect of the present invention. The door leaf is mounted in a door frame 380 by means of hinges or pivots on its longitudinal edge opposite to the free longitudinal edge 340 seen in FIG. 6. The door leaf comprises a core 42. In this embodiment the core 42 itself forms the exterior surface of the door leaf 330A. Attached to the free longitudinal edge 340 is a lipping 350 of plastic material 60, typically polyurethane, which is bonded to the edge 340 of the core 42, and is similar to the lipping 350 shown in FIG. 5.

The lipping 350 has a channel shape in cross-section with a web 352 and first and second flanges 354 substantially perpendicular to the web 352. The interior surfaces 356 of the web 352 and flanges 354 are bonded to the core, and the exterior surfaces 358 of the flanges 354 are coplanar with the exterior surfaces of the surface panels 44 of the door leaf 330 of FIG. 5, or with the exterior surface of the core 42 itself in the door leaf 330A of FIG. 6. Typically the flanges 354 have a depth, i.e. the distance by which the flanges 354 extend from the web 352, of between 10 and 50 mm.

The lipping 350 is formed by placing a mould 386 adjacent to the free edge 340 of the core 42. As can be seen from FIG. 9 the free edge 340 of the core is formed with recessed cut out portions on each side of the core, the recesses having a depth equal to the required thickness of the flanges 354 of the lipping 350, thereby forming a longitudinal tongue 46 at the free edge 340. The mould 386 is shown schematically in FIGS. 9 and 10, but may be made up of several components, which together form a mould surface corresponding to the exterior surface of the lipping 350 to be formed on the door leaf 330, 330A. The mould 386 is placed against the opposed exterior surfaces of the door leaf 330, as shown in FIG. 10, and is filled with plastic material 60, preferably polyurethane, in a liquid or semi-liquid state. The plastic material 60 is cured in situ to form a hard lipping which is bonded to three sides of the tongue 46 on the free edge 340 of the core 42. The mould 386 can then be removed.

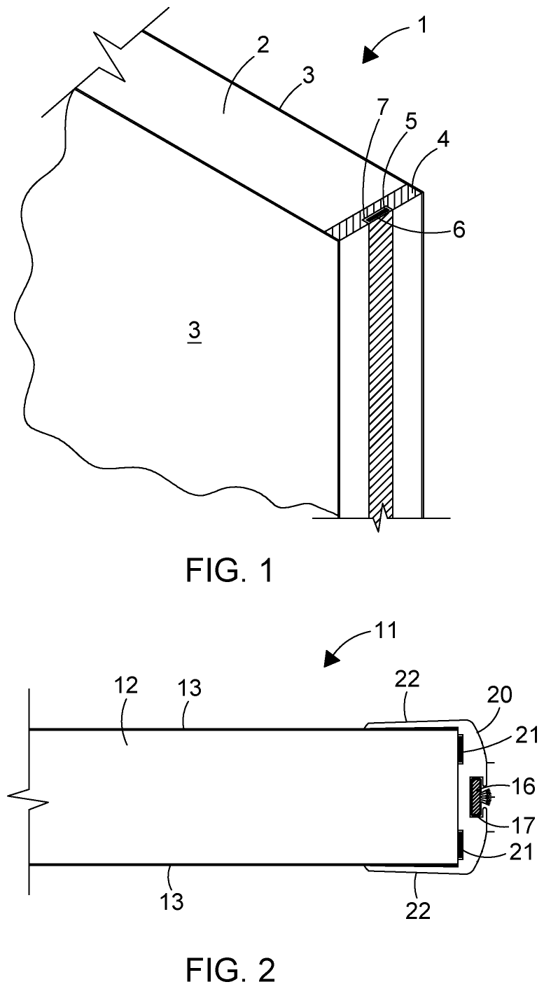

Although the embodiments of FIGS. 5 to 10 are shown without strips of intumescent material, it is to be understood that the lipping 350 can include strips of intumescent material 62 as described with reference to FIGS. 1 to 4.

Although the lipping 50, 52, 54, 56, 58, 350 is described on one longitudinal edge 40, 340 only of the door leaf core 42, it is to be understood that a lipping according to the invention can be applied to any edge of the door leaf core 42.

The intumescent material can be, but is not limited to, graphite, ammonium polyphosphate formulations or sodium silicates, and can take the form of strips of material or slurry or paste formulations.

In the door leafs according to the invention, the intumescent material is formed within the lipping in such a way that it is not visible on the edges or faces of the door. The lipping of the present invention may vary in shape and dimensions and is not limited to the shapes depicted in the drawings. The dimensions, locations and types of intumescent materials used in the invention may vary and the invention is not limited to the shapes of the strips of intumescent material illustrated in the drawings.

The plastic material of the lipping 50, 52, 54, 56, 58, 350 may be polyurethane or PVC or any other plastic material which may be formed by moulding and which may be bonded to the edge of a door leaf to provide a strong and impact resistant lipping.

The core of the door leaf may be of any construction, framed or unframed, and of any material or combination of materials, with or without separate surface panels.

The invention is not limited to the specific embodiments described, and modifications and alternatives are possible. The shape, material and size of the various components can be modified.

1. A fire resistant door leaf comprising:
a core;
a lipping extending along at least one edge of the core;
wherein the lipping is of plastic material and is bonded to the edge of the core;
wherein the lipping comprises at least one strip of intumescent material extending parallel to the edge of the core;
wherein the at least one strip of intumescent material is covered by the plastic material of the lipping and is sandwiched between the plastic material of the lipping and the core of the door leaf; and
wherein the plastic material is cast or moulded against the at least one strip of intumescent material.

2. The door leaf of claim 1, wherein the lipping comprises two strips of intumescent material extending parallel to the edge of the core, wherein the strips are arranged to be coplanar and wherein both strips are covered by the plastic material of the lipping and are sandwiched between the plastic material of the lipping and the core of the door leaf.

3-5. (canceled)

6. The door leaf of claim 1, wherein the plastic material covering the at least one strip of intumescent material is homogenous or unitary in nature and the at least one strip of intumescent material is bonded directly to the plastic material covering it by the curing of the plastic material in contact with the intumescent strip.

7. The door leaf of claim 1, wherein the plastic material of the lipping is of polyurethane.

8. The door leaf of claim 1, wherein the lipping is bonded to the core by adhesive, heat bonding, or casting.

9. The door leaf of claim 1, wherein the lipping is formed by casting or moulding to the core in a liquid or semi-liquid state and curing in situ.

10. The door leaf of claim 1, wherein the lipping is formed by casting or moulding the plastic material in a liquid or semi-liquid state around the one or more strips of intumescent material and curing the plastic material before application of the lipping to the core.

11. The door leaf of claim 1, wherein the intumescent material comprises one or more of graphite, ammonium polyphosphate, sodium silicate or mixtures or formulations thereof.

12. The door leaf of claim 1, wherein the exterior surface of the lipping is arcuate or substantially semi-circular in cross-section.

13. The door leaf of claim 1, wherein the lipping is substantially rectangular in cross-section.

14. A method of forming a fire resistant door leaf, the method comprising:
assembling a core of a door leaf;
providing at least one strip of intumescent material along at least one edge of the core; and
bonding a lipping of plastic material to the at least one edge of the core, such that the at least one strip of intumescent material is covered by the plastic material of the lipping and is sandwiched between the plastic material of the lipping and the core of the door leaf.

15. The method of claim 14, wherein the method comprises locating the at least one strip of intumescent material along the at least one edge of the core and subsequently forming the lipping by casting or moulding the plastic material of the lipping to the core in a liquid or semi-liquid state to cover the at least one strip of intumescent material and curing the plastic material in situ.

16-17. (canceled)

18. The method of claim 14, wherein the lipping is bonded to the core by adhesive, heat bonding or casting.

19. The method of claim 14, wherein the plastic material of the lipping is of polyurethane.

20. The method of claim 14, wherein the fire resistant door leaf comprises:
a core;
a lipping extending along at least one edge of the core;
wherein the lipping is of plastic material and is bonded to the edge of the core;
wherein the lipping comprises at least one strip of intumescent material extending parallel to the edge of the core;
wherein the at least one strip of intumescent material is covered by the plastic material of the lipping and is sandwiched between the plastic material of the lipping and the core of the door leaf; and
wherein the plastic material is cast or moulded against the at least one strip of intumescent material.

21-34. (canceled)
